(19) United States
(12) Patent Application Publication
(10) Pub. No.: US 2024/0165916 A1
(43) Pub. Date: May 23, 2024

(54) MULTI-LAYERED FIBROUS STRUCTURES FOR THERMOACOUSTICS APPLICATIONS

(71) Applicant: ZEPHYROS, INC., Romeo, MI (US)

(72) Inventors: Manish Taxak, Maharashtra (IN); Sivansankaran Kumaraguru, Maharashtra (IN)

(21) Appl. No.: 18/282,374

(22) PCT Filed: Apr. 4, 2022
(86) PCT No.: PCT/US2022/023248

§ 371 Date: Sep. 15, 2023

(30) Foreign Application Priority Data
Apr. 5, 2021 (IN) 202131015996
Aug. 10, 2021 (IN) 202131036154

(51) Int. Cl. B32B 5/26; B32B 3/26; B32B 3/28; B32B 3/30; B32B 5/02; B32B 5/06; B32B 5/08; B32B 15/14

(52) U.S. Cl. CPC B32B 5/266; B32B 3/266; B32B 3/28; B32B 3/30; B32B 5/022; B32B 5/073; B32B 5/08; B32B 15/14; B32B 2260/023; B32B 2260/044; B32B 2260/046; B32B 2262/144; B32B 2307/102; B32B 2307/304; B32B 2307/3065; B32B 2307/718; B32B 2307/7376; B32B 2307/738; B32B 2605/08

(57) ABSTRACT

An article comprising: (a) one or more lofted fibrous material layers comprising a lofted fibrous material; and (b) one or more nonwoven layers having a fibrous matrix; wherein the article is configured for thermoacoustic applications to thermally insulate an item or compartment; and wherein the article absorbs external heat to substantially prevent amplitude of temperature of the item or within the compartment and also substantially prevents noise fluctuation radiated by the item or out of the compartment. The article may also include one or more metallic layers disposed on one or more exterior surfaces of the article, wherein the one or more metallic layers are aluminum laminated glass cloth, aluminum foil, stainless steel, or a combination thereof. Additionally, the one or more metallic layers may also be embossed, micro-perforated, or a combination thereof.

### FIELD

The present teachings generally relate to a fibrous material, and more specifically, to a fibrous material capable of being used in applications requiring low flammability, thermal insulation, thermal absorption, acoustic insulation, or a combination thereof.

### BACKGROUND OF THE INVENTION

Various industries often require certain material properties to meet industry standards. These material properties may include structural properties (e.g., flexibility, physical strength, or both), cushioning, insulation, sound absorption, or a combination thereof. Often, industries establish specific standards to ensure the safety of people, vehicles, products, or a combination thereof. These industries include the automotive industry, the aircraft industry, the construction industry, and the marine industry. For example, the National Highway Traffic Safety Administration often requires vehicles to meet certain heat resistance minimums, flammability standards, vehicle crash-testing performance standards, or a combination thereof. Due to more demanding standards throughout the industries, the materials being utilized need to be robust, adaptable, tunable, or a combination thereof, yet not increase the cost imposed on manufacturers, customers, consumers, or a combination thereof.

The automotive industry specifically may often require materials that provide thermal insulation, sound absorption, other structural properties, or a combination thereof. Depending on where the materials are being implemented within a vehicle, the material properties may often need to meet extremely demanding requirements. For example, materials being utilized within or near an engine bay may often need heightened thermal insulation, proper air circulation, heightened flame retardance, or a combination thereof to withstand the heat output from the engine bay. Typical materials used to meet these requirements include open cell polyurethane foams, elastomeric foams, or both. However, these materials may only survive up to temperatures between about 120° C. to about 150° C. Other materials, such as fiberglass, melamine foam, or both are used when temperatures exceed 150° C. These materials may often come at an increased cost, may increase difficulty in handling during manufacturing, or both. Additionally, these materials may also pose health and safety issues, may not provide sufficient material robustness, may result in performance issues, or a combination thereof. Moreover, the alternative materials utilized over conventional foams may still not meet the temperature resistance required and may also fail to meet the necessary acoustic absorption. The alternative materials may degrade quite severely at heightened temperatures of about 180° C. to about 600° C., which causes issues with delamination, acoustic and/or thermal insulation performance, aesthetics, or a combination thereof.

Furthermore, materials may also be brittle, which creates increased dust and may make a typical manufacturing process unsafe. Along with the brittleness, alternative materials frequently used over conventional foams may often lack tunability to meet varying requirements based on different applications. As a result, the materials are often limited to specific applications, shapes, dimensions, physical properties, or a combination thereof.

Therefore, there remains a need for a material having improved thermoacoustic insulation to maintain a temperature and noise level of a desired area. What is needed is a fibrous material that absorbs excessive heat from an area. There remains a need for a material that can effectively transfer absorbed heat from a desired area. What is needed is a fibrous material having improved air circulation for excessive heat absorbed by the fibrous material. There also remains a need for a material having improved sound absorption while also being thermally resistant at heightened temperatures, being fireproof, or both. What is needed is a fibrous material that maintains structural integrity at elevated temperatures while also being fireproof and sound absorbing. Additionally, there remains a need for a material that can be adapted for a variety of applications across one or more industries. What is needed is a material that is flexible, moldable, or both to form to one or more desired applications. Moreover, there remains a need for a material that includes one or more layers that reflect heat while still maintaining improved sound absorption. What is needed is a material having one or more perforated reflective layers that reflect heat yet allow for sound absorption.

### SUMMARY

The present teachings meet one or more of the present needs by providing an article comprising: (a) one or more lofted fibrous material layers comprising a lofted fibrous material; and (b) one or more nonwoven layers having a fibrous matrix; wherein the article is configured for thermoacoustic applications to thermally insulate an item or compartment; and wherein the article absorbs external heat to substantially prevent amplitude of temperature of the item or within the compartment and also substantially prevents noise fluctuation radiated by the item or out of the compartment.

The present teachings may also provide an article, wherein: the item to be insulated may be a cabin of a vehicle, an engine bay of the vehicle, or both. The external heat, the noise fluctuation, or both may radiate from an engine bay. Additionally, the article may be temperature resistant and temperature absorbent at a temperature range of about −30° C. to about 650° C. The fibrous matrix may include fibers selected from silica fibers, polyester (PET), polyacrylonitrile (PAN), oxidized polyacrylonitrile (Ox-PAN, OPAN, or PANOX), aramid, olefin, polyamide, imide, polyetherketone (PEK), polyetheretherketone (PEEK), poly(ethylene succinate) (PES), mineral, ceramic, natural, another inorganic fiber, or another polymeric fiber. The lofted fibrous material may be selected from silica fibers, polyester (PET), polyacrylonitrile (PAN), oxidized polyacrylonitrile (Ox-PAN, OPAN, or PANOX), aramid, olefin, polyamide, imide, polyetherketone (PEK), polyetheretherketone (PEEK), poly(ethylene succinate) (PES), mineral, ceramic, natural, another inorganic fiber, or another polymeric fiber. Moreover, the article may include one or more metallic layers disposed on one or more exterior surfaces of the article.

The presenting teachings may also provide an article, wherein the one or more nonwoven material layers and the lofted fibrous material layers are thermoformed to form the article. Additionally, one or more air pockets may be located between the one or more lofted fibrous material layers and the one or more nonwoven material layers. The one or more lofted fibrous material layers and the one or more nonwoven layers may be secured to one another via stitching, bonding, or both to form the article. The article may include one or more localized flexible regions, one or more localized rigid regions, or both. Additionally, the lofted fibrous material may be generally vertically, near-vertically, or horizontally oriented. Similarly, the fibrous matrix may include fibers that are generally vertically, near-vertically, or horizontally oriented. The lofted fibrous material and the fibrous matrix may be made from generally the same fibers. The lofted fibrous material and the fibrous matrix may be made from different fibers. At least one of the one or more nonwoven material layers may be a fiber cement or rigid layer. The article may include at least two abutting nonwoven material layers sandwiched between at least two lofted fibrous material layers, and the article may be thermoformed or flat-cut. The one or more metallic layers may be aluminum laminated glass cloth, aluminum foil, stainless steel, or a combination thereof. The one or more metallic layers may be embossed, micro-perforated, or a combination thereof.

The one or more lofted fibrous material layers and the one or more nonwoven material layers may each have a thickness of no greater than 60 mm. The fibers of the lofted fibrous material may have a weight of about 400 to about 2000 GSM. The one or more lofted fibrous layers, the one or more nonwoven layers, or both may include a thermoplastic high-temperature binder to promote molding of the article. The one or more lofted fibrous layers, the one or more nonwoven layers, or both may include bicomponent fibers, wherein an outer sheath of the bicomponent fibers has a melting temperature greater than 160° C.

The present teachings meet one or more of the present needs by providing: a material having improved thermoacoustic insulation to maintain temperature and noise level of a desired area; a fibrous material that absorbs excessive heat from an area; a material that can effectively transfer absorbed heat from a desired area; a fibrous material having improved air circulation for excessive heat absorbed by the fibrous material; a material having improved sound absorption while also being thermally resistant at heightened temperatures, being fireproof, or both; a fibrous material that maintains structural integrity at elevated temperatures while also being fireproof and sound absorbing; a material that can be adapted for a variety of applications across one or more industries; a material that is flexible, moldable, or both to form to one or more desired application; a material that includes one or more layers that reflect heat while still maintaining improved sound absorption; a material having one or more perforated reflective layers that reflect heat yet allow for sound absorption; or a combination thereof.

### BRIEF DESCRIPTION OF THE DRAWINGS

FIG. 1 is a cross-section of a multi-layered fibrous article.

FIG. 2 is a cross-section of a multi-layered fibrous article.

FIG. 3 is a cross-section of a multi-layered fibrous article.

FIG. 4 is a top-down view of a fibrous article.

FIG. 5 is a cross-section of a multi-layered fibrous article.

FIG. 6 is a cross-section of a multi-layered fibrous article.

FIG. 7 is a cross-section of a multi-layered fibrous article.

FIG. 8 is a cross-section of a multi-layered fibrous article.

FIG. 9 is a cross-section of a multi-layered fibrous article.

FIG. 10 is a graph illustrating the random incidence sound absorption coefficient of a multi-layered fibrous article in accordance with the present teachings compared to a conventional metallic article.

FIG. 11 is a graph illustrating the random incidence sound absorption coefficient of a multi-layered fibrous article in accordance with the present teachings.

FIG. 12 is a graph illustrating the random incidence sound absorption coefficient of a multi-layered fibrous article in accordance with the present teachings.

FIG. 13 is a graph illustrating the random incidence sound absorption coefficient of various configurations of multi-layered fibrous articles in accordance with the present teachings.

FIG. 14 is a graph illustrating the impact of a metallic layer and/or an air-gap on the random incidence sound absorption coefficient of multi-layered fibrous articles in accordance with the present teachings.

FIG. 15 is a graph illustrating the impact of weight on the sound transmission loss of multi-layered fibrous articles in accordance with the present teachings.

FIG. 16 is a graph illustrating the sound transmission loss of multi-layered fibrous articles in accordance with the present teachings relative to a target value at various frequency levels.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference herein in their entirety into this written description.

Insulation materials, structural materials, acoustic absorption materials, or a combination thereof may have a wide range of applications, such as in automotive applications, aviation applications, commercial vehicle engine compartments, in-cab areas, construction equipment, agricultural applications, flooring, floormate under layments, and heating, ventilation and air conditioning (HVAC) applications. These materials may also be used for machinery and equipment insulation, motor vehicle insulation, domestic appliance insulation, and commercial wall and ceiling panel insulation. For example, insulation materials may be used in an engine cavity or along a floor of a vehicle cabin. These materials may also provide other benefits, such as sound absorption, compression resiliency, stiffness, desired structural properties, protection (e.g., to an item around which the insulation material is located), or a combination thereof. These materials may also serve as a sound attenuation material in an aircraft or a vehicle, attenuating sound originating from outside a cabin and propagating toward the inside of the cabin.

The present teachings envision the use of these insulation materials, structural materials, acoustic absorption materials, or a combination thereof to form the present article. The article may function to provide insulation to one or more items, one or more compartments, or both. For example, the article may be positioned within an engine compartment and/or underneath a floor of a vehicle cabin to insulate a vehicle cabin from heat generated within the engine compartment. The article may function to provide structural reinforcement to one or more items. The article may function to absorb sound. While an automotive vehicle compartment is specifically referenced herein, it is to be understood that the article disclosed herein can be used to provide insulation to any desired items or any desired compartments, and the teachings herein are not limited to use only within or adjacent to an engine compartment. For example, other applications may include, but are not limited to, in-cabin insulation, heat shielding for transportation and off-highway vehicles, thermoacoustic insulation in generator sets, airs compressors, HVAC units, other stationary or mobile mechanical units where heat or noise is generated, or a combination thereof. As such, it is envisioned that the article may exhibit increased thermoacoustic performance (i.e., providing improved thermal insulation and also improved acoustic absorption and/or performance).

The article may be formed into the shape of a box or other enclosure. The article may be moldable or otherwise shaped, thereby allowing for mechanical features to be in-situ nonwoven or for allowing fastening or assembly mechanisms to be included. The article may be pliable, bendable, flexible, or a combination thereof. As such, it is contemplated that the article may be bent so that the article may be secured around an item to be insulated. The article may include one or more layers. It is contemplated that the article includes a plurality of layers to improve insulation, physical properties, or both (e.g., higher density materials, porous limp sheets, fabrics, scrims, meshes, etc.). The article may be configured to absorb a temperature fluctuation caused by one or more external heat sources to maintain a desired temperature of an item, within a compartment, or both.

The article may be configured to operate within any desired temperature range. For example, the article may operate at a temperature of about −50° C. or more, about 0° C. or more, or about 100° C. or more. The article may operate at a temperature of about 650° C. or less, about 600° C. or less, or about 500° C. or less. For example, the article may operate at a temperature of about −30° C. to about 350° C. or −30° C. to about 650° C. The article may maintain a temperature of a compartment to within +/−5° C. or less, +/−3° C. or less, or even +/−1° C. or less of ambient. Moreover, the article may maintain a temperature of a compartment at ambient temperature or at open air temperature.

The present teachings envision the use of an article that is fire retardant, smoke retardant, safe and/or easier to handle, has a low toxicity (e.g., as compared to phenolic resonated based products), or any combination thereof. The article may be used for acoustic and/or thermal insulation, for providing compression resistance, for providing a material that reduces or eliminates the possibility of mold or mildew therein, or a combination thereof. The article may provide for long-term structure stability for long-term acoustic and/or thermal performance. The article may provide long-term resistance to humid environments or may be able to withstand temperature and humidity variations and fluctuations.

The article may include one or more lofted fibrous layers that function to provide insulation, acoustic absorption, structural support and/or protection to one or more items, or a combination thereof. The lofted fibrous layers may have a high loft (or thickness) at least in part due to the orientation of the fibers, the method of forming the layers, or both. For example, the fibers within the lofted fibrous layers may be cross-lapped, vertically lapped, air-laid, or a combination thereof. Thus, the fibers of the lofted fibrous layers may have a higher loft when compared to conventional fiber arrangements due to the selection of fibers, orientation of the fibers within the lofted fibrous layers, or both. The lofted fibrous layers may exhibit good resilience and/or compression resistance. The lofted fibrous layers may be able to be compressed to fit within a cavity or wall structure, such as within an engine compartment. The lofted fibrous layers due to factors such as, but not limited to, unique fibers, surfaces, physical modifications to the three-dimensional structure (e.g., via processing), orientation of fibers, or a combination thereof, may exhibit good thermal insulation capabilities versus traditional insulators.

It is contemplated that the lofted fibrous layers may be adjusted based on the desired properties for a given application. The lofted fibrous layers may be tuned to provide a desired weight, thickness, compression resistance, other physical attribute, or a combination thereof. For example, the lofted fibrous layers may have a weight of about 100 grams per square meter (GSM) or more, about 500 GSM or more, or about 1,500 GSM or more. The lofted fibrous layers may have a weight of about 4,000 GSM or less, about 3,000 GSM or less, or about 2,000 GSM or less. The lofted fibrous layers may be tuned to provide a desired thermal conductivity and acoustics performance. The lofted fibrous layer may be thermoformable so that the lofted fibrous layers may be molded or otherwise shaped to fit within a channel or hollow cavity of the structure to be insulated and/or reinforced. The thermoforming may be possible due to one or more binding agents present in the lofted fibrous layers or may be due to inherent properties of fibers selected.

The lofted fibrous layers may be substantially uniform or may vary depending on the application. For example, each lofted fibrous layer may incorporate the same type of fibers, may have a substantially similar loft, may have a substantially similar fiber orientation (e.g., each lofted fibrous layer is vertically lapped, cross-lapped, or a combination thereof), may have a substantially similar weight, or a combination thereof. Alternatively, or additionally, the lofted fibrous layers may vary in one or more of the aforementioned properties to further tune one or more characteristics of the article. Therefore, it should be clear from the present teachings that the article may be highly customizable to meet the demands of any given application.

The fibers that make up the lofted fibrous layers may have an average linear mass density of about 0.5 denier or greater, about 1 denier or greater, or about 5 denier or greater. The material fibers that make up the lofted fibrous layers may have an average linear mass density of about 25 denier or less, about 20 denier or less, or about 15 denier or less. Fibers may be chosen based on considerations such as cost, resiliency, desired thermal conductivity, acoustics performance, or the like. For example, a coarser blend of fibers (e.g., a blend of fibers having an average denier of about 12 denier) may help provide resiliency to the lofted fibrous layers. A finer blend may be used, for example, if thermal conductivity and acoustics are desired to be further controlled. The fibers may have a staple length of about 20 millimeters or greater, or even up to about 150 millimeters or greater (e.g., for carded fibrous webs). For example, the length of the fibers may be between about 30 millimeters and about 100 millimeters. The fibers may have an average or common length of about 50 to 60 millimeters staple length, or any length typical of those used in fiber carding processes. Short fibers may be used (e.g., alone or in combination with other fibers) in any lofted fibrous processes, such as the formation of air laid fibrous webs. For example, some or all of the fibers may be a powder-like consistency (e.g., with a fiber length of about 2 millimeters to about 3 millimeters, or even smaller, such as about 200 microns or greater or about 500 microns or greater). Fibers of differing lengths may be combined to provide desired insulation and/or acoustic properties. The fiber length may vary depending on the application; the insulation properties desired; the acoustic properties desired; the type, dimensions and/or properties of the lofted fibrous layers (e.g., density, porosity, desired air flow resistance, thickness, size, shape, and the like of the lofted fibrous layers and/or any other layers of the article); or any combination thereof. The addition of shorter fibers, alone or in combination with longer fibers, may provide for more effective packing of the fibers, which may allow pore size to be more readily controlled in order to achieve desirable characteristics (e.g., acoustic and/or thermal insulation characteristics).

The fibers forming the lofted fibrous layers may be natural or synthetic fibers. Suitable natural fibers may include cotton, jute, wool, cellulose, PANOX, glass, silica, and ceramic fibers. Suitable synthetic fibers may include silica, PANOX, polyester, polypropylene, polyethylene, nylon, aramid, imide, acrylate fibers, or a combination thereof. The fibrous layers may comprise polyester fibers, such as polyethylene terephthalate (PET), and co-polyester/polyester (CoPET/PET) adhesive bi-component fibers. The fibers may include polyacrylonitrile (PAN), oxidized polyacrylonitrile (Ox-PAN, OPAN, or PANOX), olefin, polyamide, polyetherketone (PEK), polyetheretherketone (PEEK), poly(ethylene succinate), polyether sulfonate (PES), or other polymeric fibers. The fibers may include glass, silica, mineral, or ceramic fibers. The fibers may be formed of any material that is capable of being carded and lapped into a three-dimensional structure. The fibers may be 100% virgin fibers or may contain fibers regenerated from postconsumer waste (for example, up to about 90% fibers regenerated from postconsumer waste or even up to 100% fibers regenerated from postconsumer waste). The fibers may have or may provide improved thermal insulation properties, acoustic insulation properties, or both. The fibers may have relatively low thermal conductivity. The fibers may be flame-retardant, heat resistant, or both. The fibers may be water repellant, water resistant, or both. The fibers may be antimicrobial, antifungal, or both. The fibers may have geometries that are non-circular or non-cylindrical to alter convective flows around the fiber to reduce convective heat transfer effects within the three-dimensional structure. The lofted fibrous layers may include or contain engineered aerogel structures to impart additional thermal insulating benefits.

The fibers in the lofted fibrous materials, the nonwoven materials, or both may be bicomponent fibers. The bicomponent fibers may include an outer sheath around a central portion. As a result, the outer sheath may have a melting temperature different or similar to the central portion. For example, the outer sheath may have a melting temperature greater than 160° C. The bicomponent fibers may be intermingled, woven, or both with one or more layers of the article. The bicomponent fibers may also be bonded to one or more layers of the article (e.g., thermobonding).

It is also envisioned that the fibers and materials utilized in the article may substantially prevent weight change of the article during operation. For example, due to the thermal resistance of the article, the mass of the article may be substantially maintained during operation. The mass of the article after being heated to elevated temperatures, such as about 500° C. or more, may be about 100% of the original mass, about 90% or more of the original mass, or about 80% or more of the original mass.

The article may also include one or more nonwoven layers that may function to further improve thermal insulation, acoustic absorption, structural support and/or protection to one or more items, or a combination thereof. The nonwoven layers may provide structure or rigidity to the article. The nonwoven layers may be formed into any desired shape to meet a given application. The molding may be possible due to one or more binding agents present in the nonwoven layers or due to inherent properties of chosen fiber materials. The binding agents may facilitate the nonwoven layers retaining a desired shape. The nonwoven layers may form a shape of the overall article. For example, the nonwoven layers may be formed to have a desired contour, and the lofted fibrous layers may follow a contour of the nonwoven layers when secured to the nonwoven layers. The nonwoven layers may be thermoformable to allow for the nonwoven layers to meet any desired dimensions. The nonwoven layers may have one or more contours, one or more arcuate portions, one or more linear segments, one or more steps, one or more bumps, one or more undulations, one or more convex portions, one or more concave portions, one or more divots, or a combination thereof. The nonwoven layers may retain a desired shape after thermoforming. The desired shape may mate with a shape of one or more items, one or more compartments, or both. For example, the nonwoven layers may be molded to follow a contour of an engine compartment or a vehicle.

The nonwoven layers may exhibit similar properties to the lofted fibrous layers. The nonwoven layers and the lofted fibrous layers may both provide insulation, provide structural support, provide acoustic absorption, or a combination thereof. Alternatively, the nonwoven layers may exhibit properties dissimilar to the lofted fibrous layers. The nonwoven layers may provide structural integrity to the article while the lofted fibrous layers may provide compressibility to the article. For example, the nonwoven layers may be more rigid than the lofted fibrous layers to prevent excessive bending of the article while the lofted fibrous layers are a high lofted material that may compress upon an application of force. Therefore, it is contemplated that the nonwoven layers may be adjusted based on the properties for a given application in conjunction with, or in lieu of, adjusting the lofted fibrous layers. The nonwoven layers may be tuned to provide a desired weight, thickness, compression resistance, other physical attribute, or a combination thereof. For example, the nonwoven layers may have a weight of about 50 GSM or more, about 100 GSM or more, about 500 GSM or more, or about 1,500 GSM or more. The nonwoven layers may have a weight of about 4,500 GSM or less, about 4,000 GSM or less, or about 3,000 GSM or less, or about 2,000 GSM or less.

The nonwoven layers may be made up of a fiber matrix. The fiber matrix may be of a relatively low weight yet still exhibit good resiliency and thickness retention. The fiber matrix, due to factors such as, but not limited to, unique fibers, facings, physical modifications to the three-dimensional structure (e.g., via processing), orientation of fibers, or a combination thereof, may exhibit good thermal insulation capabilities or thermal conductivity (e.g., lower) along with acoustic performance versus traditional insulation materials. The fiber matrix, and thus the nonwoven layers, may retard fire and/or smoke. The fiber matrix, or parts thereof, may be capable of withstanding high temperatures without degradation (e.g., temperatures up to about 1150° C. for a shorter duration and 600 to 650° C. for continuous exposure). The fiber matrix may provide structural properties or may provide physical strength to the nonwoven layers. The fiber matrix may provide insulative properties. The fiber matrix may function to provide high temperature resistance, acoustic absorption, structural support, and/or protection to one or more areas of the article within which the nonwoven layers are located.

The fiber matrix may be made up of fibers. The fibers that make up the nonwoven layers may be the same or dissimilar to the fibers that make up the lofted fibrous layers. For example, both the lofted fibrous layers and the nonwoven layers may include the same organic and/or inorganic fibers, the manufacturing process, additives within the layers, orientation of the fibers within the layers, dimensions of the individual fibers, or a combination thereof may dictate resultant properties of each other. As such, it is contemplated that the lofted fibrous layers and the nonwoven layers may comprise substantially similar fibers, yet the lofted fibrous layers and the nonwoven layers may exhibit substantially unique structural properties. For example, the lofted fibrous layers may be a high lofted material to promote air circulation throughout the article while the nonwoven layers may be compressed to have a substantially more rigid structure when compared to the lofted fibrous layers.

At least some of the fibers forming the fiber matrix of the nonwoven layers may be of an inorganic material. The inorganic material may be any material capable of withstanding temperatures of about 250° C. or greater, about 500° C. or greater, about 650° C. or greater, or about 1000° C. or greater. The inorganic material may be a material capable of withstanding temperatures up to about 700° C. (e.g., up to about 650° C.). The fibers of the fiber matrix may include a combination of fibers having different melting points. For example, fibers having a melting temperature of about 200° C. may be combined with fibers having a higher melting temperature, such as about 750° C. When these fibers are heated above the melting temperature of the lower melt temperature fibers (e.g., exceeding 200° C.), the lower melt temperature fibers may melt and bind to the higher temperature fibers. The inorganic fibers may have a limiting oxygen index (LOI) via ASTM D2836 or ISO 4589-2 for example that is indicative of low flame or smoke. The LOI of the inorganic fibers may be higher than the LOI of standard binder fibers. The inorganic fibers may be present in the fiber matrix in an amount of about 60 percent by weight or greater, about 70 percent by weight or greater, about 80 percent by weight or greater, or about 90 percent by weight or greater. The inorganic fibers may be present in the fiber matrix in an amount of about 100 percent by weight or less. The inorganic fibers may be selected based on a desired stiffness. The inorganic fibers may be crimped or non-crimped. Non-crimped organic fibers may be used when a fiber with a larger bending modulus (or higher stiffness) is desired. The inorganic fibers may be wet-laid. The inorganic fibers may be ceramic fibers, silica-based fibers, glass fibers, mineral-based fibers, or a combination thereof. Ceramic and/or silica-based fibers may be formed from polysilicic acid (e.g., Sialoxol or Sialoxid), or derivatives of such. For example, the inorganic fibers may be based on an amorphous aluminum oxide containing polysilicic acid. The fibers may include about 99% or less, about 95% or less, or about 92% or less SiO2. The remainder may include —OH (hydroxyl or hydroxy) and/or aluminum oxide groups. Siloxane, silane, and/or silanol may be added or reacted into the fiber matrix to impart additional functionality. These modifiers may include carbon-containing components.

The inorganic fibers may provide excellent insulation characteristics. The inorganic fibers may be a non-combustible textile fiber, such as BELCOTEX® (e.g., BELCOTEX® 90, BELCOTEX® 110, or BELCOTEX® 225), available from BELCHEM GmbH, Kesselsdorf, Germany, or silica fiber based.

The fiber matrix may comprise one or more structural fibers. The structural fibers may be a fiber cement material. It is contemplated that the structural fibers may be included to further improve flame retardance of the article. The structural fibers may have any desired specifications based on a given application. For example, the structural fibers may have a weight of about 100 GSM or more, about 500 GSM or more, or about 1000 GSM or more. The structural fibers may have a weight of about 2,000 GSM or less, about 1,500 GSM or less, or about 1,250 GSM or less. The nonwoven layers may include the structural fibers disposed within cement to reinforce the cement and form the nonwoven layer. As such, the structural fibers may reinforce a cement layer to provide further flame retardance, structural integrity (e.g., impact resistance), or both to the article.

The nonwoven layers may be substantially uniform or may vary depending on the application. For example, each nonwoven layer may incorporate the same type of fibers, may have a substantially similar thickness, may have a substantially similar fiber orientation (e.g., each nonwoven layer includes a similar fiber matrix orientation), may have a substantially similar weight, or a combination thereof. Alternatively, or additionally, the nonwoven layers may vary in one or more of the aforementioned properties to even further tune one or more characteristics of the article.

The lofted fibrous layers and the nonwoven layers may be secured to one another to form the article. The layers may be attached to each other by one or more lamination processes, one or more adhesives, heat sealing, sonic or vibration welding, pressure welding, another mechanical connection, or a combination thereof. For example, the layers may include an adhesive film between each other to connect the layers and form the article.

It is contemplated that the layers may be secured to one another mechanically using stitching. The stitching may function to secure or interconnect all or some of the layers of the article together. The stitching that forms the seams may interconnect the layers to form an overall shape of the article. The stitching may extend through an entire thickness of the article or only a portion of the article. The stitching may be any desired threading material to meet the demands of an application. For example, the stitching may be flame retardant, heat resistant, thermally insulating, or a combination thereof. The stitching may be disposed anywhere along the layers of the article in any desired fashion. The stitching may extend through preformed holes or more be pierced through the layers via a needle. The stitching may seal a periphery of the article or may create one or more openings. The stitching may compressibly secure the lofted fibrous layers and the nonwoven layers together. As such, the layers may follow a contour of one another to form the overall contour of the article.

The stitching may form one or more panels of the article. The panels may make up the overall article dimensions. The panels may interconnect. The panels may be a unitary piece and the panels may be distinguished from one another via the stitching. The panels may provide additional structural rigidity to the article, compressibility to the article, or both. The panels may be any desired size and/or shape. The article may include a single panel or a plurality of panels. For example, the article may be stitched along a periphery to secure each layer to each other so that the article may form a single panel.

Due to the stitching or other connection means, the article may include one or more localized lofted regions, one or more localized compressed regions or a combination thereof. The localized regions may result in the article having localized rigid regions and/or localized compressible regions. For example, the article may be substantially rigid along any connection regions (i.e., near stitching, thermoformed portions, adhesive portions, etc.) while any remaining regions may be compressible.

The panels may include one or more pockets. The pockets may function to provide further loft to the article. The pockets may function to provide improved air circulation throughout the article to maintain a temperature within a compartment being insulated, maintain a temperature of an item being insulated, or both. The pockets may also improve acoustic performance (e.g., noise insulation) of the article. The pockets may be a hollow air pocket. Alternatively, the pockets may be filled with one or more additional insulation or structural materials. For example, the pockets may be filled with loose particles and/or fibers for further insulation yet the loose particles and/or fibers promotes air circulation. The pockets may be any size and/or shape. The pockets may be formed between two abutting lofted fibrous layers, between two abutting nonwoven layers, between an abutting nonwoven layer and a lofted fibrous layer, or a combination thereof. The pockets may be compressible. The pockets may form a structurally rigid cavity. A shape of the pockets may be dictated by a contour of the lofted fibrous layers, nonwoven layers, or both that mate to form the pockets. The pockets may be formed by stitching around a given area of the one or more adjacent layers. The pockets may be positioned between any layers of the article.

One or more exterior surfaces of the article may include a metallic layer. The metallic layer may be reflective to reflect heat. The metallic layer may be formed by a coating applied to one or more surfaces of the article so that the coating may have high infrared reflectance or low emissivity. The metallic layer may be an extension of the lofted fibrous layers, the nonwoven layers, or both. For example, fibers along an outer surface of the nonwoven layers may form the reflective layer. At least some of the surfaces of the lofted fibrous layers, nonwoven layers, or both may be metallized to provide infrared (IR) radiant heat reflection to form the reflective layer. To provide heat reflective properties to protect the article, one or more layers may be metalized. For example, fibers of the nonwoven layers may be aluminized. The fibers themselves may be infrared reflective (e.g., so that an additional metallization or aluminization step may not be necessary). Metallization or aluminization processes can be performed by depositing metal atoms onto the fibers of the layers. As an example, aluminization may be established by applying a layer of aluminum atoms to the layers.

Alternatively, or additionally, the metallic layer may be a separate layer disposed on top of one or more exterior surfaces of the article. The metallic layer may be adhered to an exterior surface of the article. The metallic layer may be fastened to the article (e.g., stitched and/or adhered to the article along with the interconnected layers). The metallic layer may be a foil, film, or both. The reflective layer may be metallic. For example, the metallic layer may be an aluminum foil, an aluminum laminated glass cloth, a tin foil, bronze foil, stainless steel (e.g., SS-304, SS-316, SS-430), other metals, or a combination thereof.

The metallic layer may be micro-perforated, embossed, or both. The micro-perforation of the metallic layer may further improve acoustic performance of the article. Additionally, the micro-perforation may facilitate thinner metallic layers being utilized, thereby decreasing the overall weight of the article while maintaining performance. The micro-perforation of the metallic layer may be in any desired pattern. As such, the micro-perforation may be uniform or nonuniform. The micro-perforation may also include perforations of any desired dimension. Similarly, substantially all or only a portion of the metallic layer may be perforated based upon a given application.

The metallic layers may also be embossed. As such, the metallic layers may include micro-perforations, embossment, or both. Embossing of the metallic layers may be done uniformly or nonuniformly. Embossing may be done in any desired shape and/or pattern. The embossing may form localized regions of greater stiffness, greater flexibility, or both. The embossing may be designed to mate with one or more surfaces of an article or compartment being insulated. As such, the embossing may even further improve acoustic performance of the article.

Beneficially, the metallic layer may be any desired thickness to promote sufficient reflection and insulation of the article. For example, if the metallic layer is a foil disposed over one or more layers of the article. The metallic layer may have a thickness of about 50 microns or more, about 150 microns or more, or about 250 microns or more. The metallic layer may have a thickness of about 500 microns or less, about 400 microns or less, or about 300 microns or less.

Similarly, the metallic layer may include a plurality of layers to make up the overall metallic layer. For example, a first and a second metallic layer may abut each other within the article to provide an overall metallic portion of the article. As such, an outermost metallic layer (e.g., the first metallic layer or the second metallic layer) may act as a facing layer to directly face an external heat source. Thus, the secondary metallic layer adjacent to the facing layer may provide even further insulation or reflective characteristics of the article. For example, a facing metallic layer may be an aluminum foil while an adjacent secondary metallic layer may be stainless-steel, or vice versa.

If the metallic layer is a foil, it may be disposed directly over one or more of the layers of the article, such as a nonwoven layer, a lofted fibrous layer, or a combination thereof. The disposition of the metallic layer may be in direct planar contact with one or more layers of the article such that the abutment between the metallic layer and the one or more layers of the article is substantially free of any gap. Conversely, the metallic layer may form one or more pockets between the metallic layer and the one or more layers of the article. While the metallic layer described above may include embossing and/or micro-perforation, it should also be noted that the metallic layer may be free of any embossment or perforations such that the metallic layer is substantially planar.

Any layers of the article may have a desired thickness that provides the desired properties of the articles. The layers may have a thickness of about 2 mm or more, about 5 mm or more, or about 20 mm or more. The layers may have a thickness of about 50 mm or less, about 40 mm or less, or about 30 mm or less. Each layer (e.g., the lofted fibrous layers, the nonwoven layers, or both) may have a similar thickness or may vary in thickness.

As described herein, the lofted fibrous layers, the nonwoven layers, or both may be thermoformable. The thermoforming may result from heating and then forming the layers into a specifically shaped thermoformed product. It is envisioned that the thermoforming may be promoted by a binder (e.g., a high-temperature binder) present in one or more of the layers, such as the nonwoven layers, to mold the fibers of the layers and form a desired shape. For example, the nonwoven and lofted fibrous layers may be thermoformed to create the article. While thermoforming may be completed to form substantially all or a portion of the article, additional layers of the article may be free of thermoforming. For example, the metallic layers may be pre-formed and disposed over a thermoformed article.

Additionally, during forming of the article, one or more additional strengthening features may be implemented. The strengthening features may be one or more ribs, gussets, channels, beads, bends, angles, embossments, perforations, or a combination thereof. The strengthening features may function to improve structural integrity of the article during use. These strengthening features may be positioned and/or tuned based upon a given application. For example, the strengthening features may be ribs that abut a mating channel along an inner surface of a cavity to maintain a substantially flush mating between the article and the cavity surface. However, it should also be noted that the article may be free of any strengthening features, or that one or more layers may include a strengthening feature while one or more additional layers are free of a strengthening feature.

The layers may have a varying thickness (and therefore a varied or non-planar profile) along a length of the layers. Areas of lesser thickness may be adapted to provide controlled flexibility to the layers, such as to provide an area that is folded (to fit within a hollow cavity to be insulated) or otherwise shaped, such as to form a corner or angled portion (e.g., to serve as the vertex between two thicker portions of the material) to allow the layers to be shaped. The layers may be shaped (e.g., by folding, bending, thermoforming, molding, and the like) to produce a box-like structure, or a structure generally matching the shape of the area to be insulated.

It should be noted that the article may be formed by alternating nonwoven layers and lofted fibrous layers. One or more lofted fibrous layers may be sandwiched between nonwoven layers. Two lofted fibrous layers may sandwich a nonwoven layer. The article may include a disproportionate amount of lofted fibrous layers to nonwoven layers. For example, the article may have more nonwoven layers than lofted fibrous layers, or vice versa. The article may include a plurality of surface layers (e.g., reflective layers) on the nonwoven layers, the lofted fibrous layers, or both. The surface layers may be on an exterior surface of the article or may be on an interior layer surface (e.g., on a lofted fibrous layer sandwiched between nonwoven layers).

The total thickness of the article may depend upon the number and thickness of the individual layers. It is contemplated that the total thickness may be about 5 mm or more, about 50 mm or more, or about 100 mm or more. The total thickness may be about 200 mm or less, about 150 mm or less, or about 120 mm or less. For example, the total thickness of the article may be from about 2 mm to about 40 mm, or even from about 5 mm to about 10 mm. Thus, it may be gleaned from the present teachings that the total thickness of the article may be selected or configured based on a given application (e.g., to provide a greater ability to withstand heightened temperatures (i.e., temperatures greater than about 500° C.), provide smaller packaging requirements, etc.). It should also be noted that the total thickness may be uniform throughout the article or may include localized areas of greater thickness relative to the overall thickness of the article, areas of less thickness relative to the overall thickness of the article, or both. As such, one or more sections of the article may have different thicknesses, may have the same thickness, or both.

It is also contemplated that some of the individual layers may be thicker than other layers. For example, the thickness of the lofted fibrous layers may be greater than the thickness of the nonwoven layers (individually or combined). The total thickness of the lofted fibrous layers may be greater than the total thickness of the nonwoven layers. The thickness may vary between the same types of layers as well. For example, two lofted fibrous layers in the article may have different thicknesses. The article may be tuned to provide desired insulation characteristics and/or more general broad band sound absorption by adjusting the specific air flow resistance and/or the thickness of any or all of the layers.

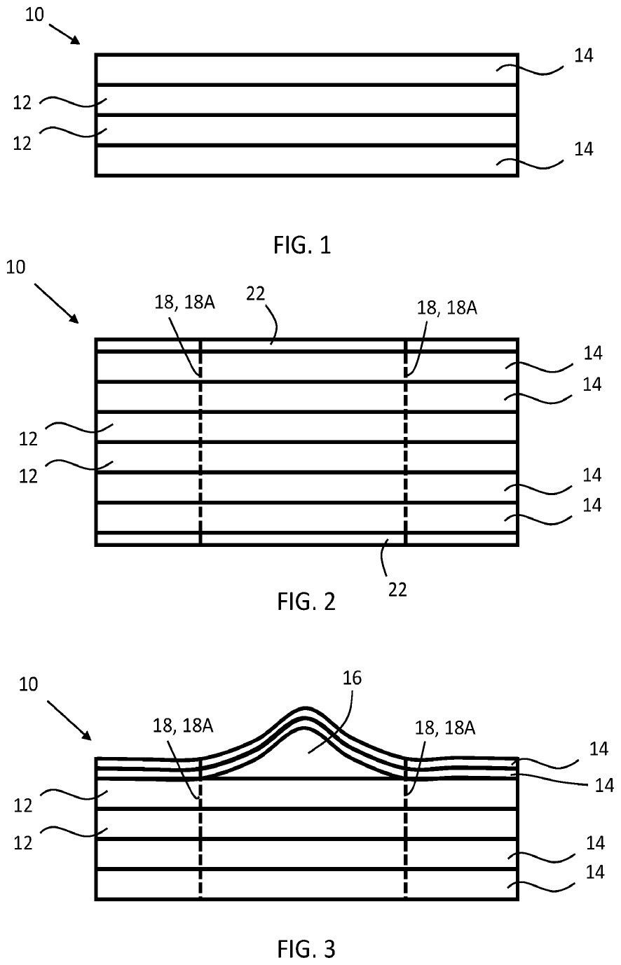

Turning now to the figures, FIG. 1 illustrates a cross-section of an article 10. The article 10 includes a pair of abutting lofted fibrous layers 12 sandwiched between nonwoven layers 14.

FIG. 2 illustrates a cross-section of an article 10. The article 10 includes a pair of abutting lofted fibrous layers 12 sandwiched between a plurality of nonwoven layers 14. Metallic layers 22 are disposed on opposing exterior surfaces of the article 10. As illustrated, a bonding region 18 created by stitching 18A the lofted fibrous layers 12 and the nonwoven layers 14 together secures the article 10 together. However, it should also be noted that the bonding region 18 may be free of stitching 18A and may bond the layers together via alternative methods, such as adhesives, mechanical interlocking, etc.

FIG. 3 illustrates a cross-section of an article 10. The article 10 includes a pair of abutting lofted fibrous layers 12 sandwiched between a plurality of nonwoven layers 14. Metallic layers 22 are disposed on opposing exterior surfaces of the article 10. As illustrated, A bonding region 18 having stitching 18 created by sewing the lofted fibrous layers 12 and the nonwoven layers 14 together secures the article 10 together. Furthermore, an air pocket 16 is formed between the nonwoven layer 14 and the lofted fibrous layer 12 to improve air circulation throughout the article 10, heat absorption by the article 10, or both. It should be noted that while FIGS. 1-3 illustrate exemplary cross-sections of an article 10, the article 10 may include any desired number of lofted fibrous layers 12, nonwoven layers 14, or both.

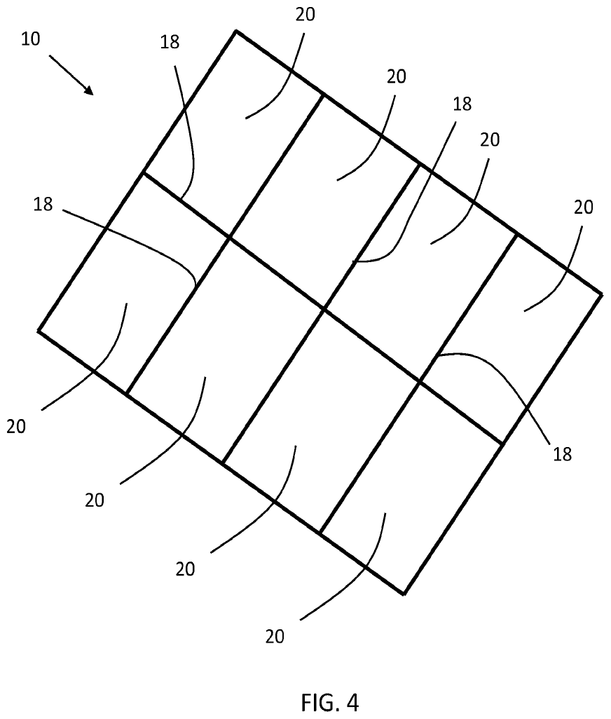

FIG. 4 illustrates a top-down view of an article 10. As illustrated, the article 10 may include a plurality of panels 20 formed by bonding regions 18 securing a plurality of layers of the article 10 together. It is contemplated that one or more of the panels 20 may include an air pocket formed by flexing one or more of the layers of the article 10 together to secure the layers to each other (see FIG. 3). Moreover, the bonding regions 18 may be locally compressed or otherwise substantially rigid when compared to an inner portion of the panels 20. Thus, the panels 20 may be more flexible and/or compressible when compared to the rigidity of the bonding regions 18. However, it is also envisioned that the rigidity or flexibility of the article 10 may be substantially uniform (i.e., the bonding regions 18 have a pliability similar to the panels 20).

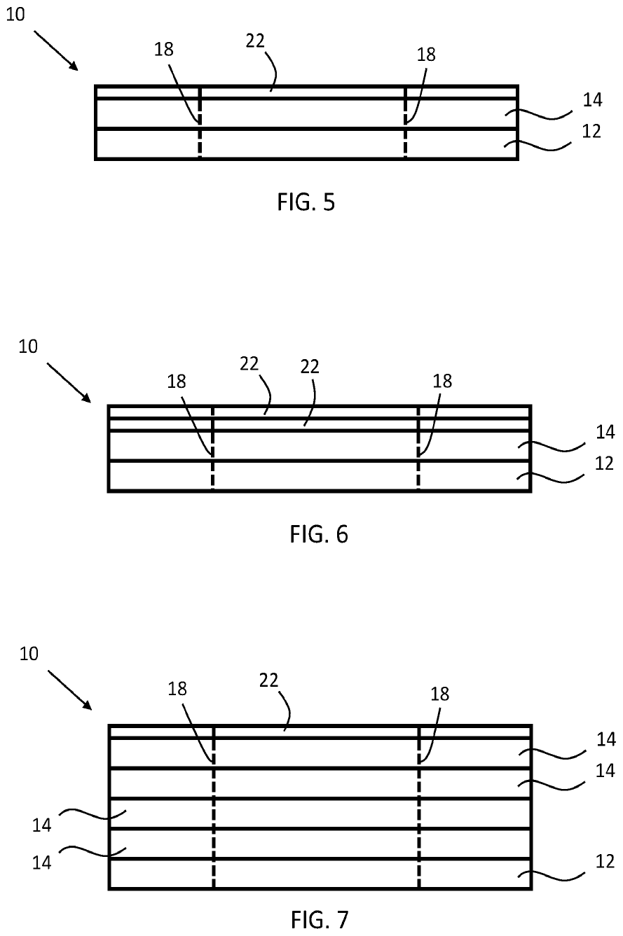

FIG. 5 illustrates a cross-section of an article 10. The article 10 may include a lofted fibrous layer 12 abutting a nonwoven layer 14. A metallic layer 22 is disposed over the nonwoven layer 14 free of contact with the lofted fibrous layer 12. However, it should also be noted that the metallic layer 22 may be in contact with any desired layer based on a given application. Beneficially, it is envisioned that the metallic layer 22 may be positioned as a facing layer that faces an external heat source, thereby deflecting the heat away from the article 10. The layers are then bonded together along a bonding region 18 joining all of the layers to form the article 10.

As shown, the article 10 of FIG. 5 beneficially includes only a single layer for each of the lofted fibrous layer 12, the nonwoven layer 14, and the metallic layer 22. As discussed above in reference to FIGS. 1-3, the article 10 may be tuned to include a plurality of lofted fibrous layers 12, nonwoven layers 14, metallic layers 22, or a combination thereof. However, a single layer for each of the lofted fibrous layer 12, the nonwoven layer 14, and the metallic layer 22 may advantageously even further decrease weight of the article 10 when compared to conventional solutions while still maintaining an increased or optimized level of performance. By eliminating additional layers of the lofted fibrous layers 12, the nonwoven layers 14, and the metallic layers 22, packaging of article 10 may also be improved by decreasing the overall thickness of the article 10, yet still advantageously providing acceptable heat resistance and insulation at heightened temperatures.

As discussed above, the lofted fibrous layer 12, the nonwoven layer 14, and the metallic layer 22 may be selected from a number of materials to provide even further tunability based on a given application. For example, the metallic layer 22 may be either an aluminum foil, a stainless-steel foil, another metallic material, or a combination thereof. Similarly, the lofted fibrous layer may be selected from any number of organic and/or inorganic fibers, such as carbon fiber, oxidized polyacrylonitrile fiber, other fibers, or a combination thereof. Additionally, the nonwoven layers may also include organic and/or inorganic fibers, such as silica fibers, and one or more binders to promote molding of the nonwoven layers.

FIG. 6 illustrates a cross-section of an article 10 similar to the article shown in FIG. 5. The article 10 may include a nonwoven layer 14 adjacent to a lofted fibrous layer 12. Similar to the article of FIG. 5, a metallic layer 22 may be disposed over the nonwoven layer 14. However, an additional metallic layer 22, acting as a facing layer, may be disposed over the first metallic layer 22 to provide further reflective properties to the article 10. All of the layers may then be secured to each within one or more bonding regions 18 to form the article 10.

The metallic layers 22 may be the same material or may be different materials. For example, the facing outermost metallic layer 22 may be stainless-steel while the metallic layer 22 in direct contact with the nonwoven layer 14 may be aluminum. Similarly, the metallic layers 22 may have similar thicknesses or may vary in thickness.

FIG. 7 illustrates a cross-section of an article 10. The article 10 includes a plurality of abutting nonwoven layers 14. A metallic layer 22 is disposed on an exterior surface of the article 10 in contact with one of the nonwoven layers 14. Additionally, a lofted fibrous layer 12 may be disposed on an opposing side of the nonwoven layers 14 from the metallic layer 22 and the layers may be secured together within one or more bonding regions 18 to form the article 10. As such, it is envisioned that the metallic layer 22 may act as a facing layer and may be directed towards an external heat source, thereby at least partially protecting the nonwoven layers 14 and the lofted fibrous layer 12 from the external heat source.

The nonwoven layers 14 may all be similar constructions or may vary in properties, materials, characteristics, or a combination thereof. For example, one or more of the nonwoven layers 14 may be moderate and/or high temperature-resistance inorganic silica fibers having one or more binders. Additionally, one or more other nonwoven layers 14 may include similar silica fibers yet be formed into a hardsheet, such as an Engineered Compact Fibers (ECF) hardsheet, intended to specifically tune acoustical performance of the article 10.

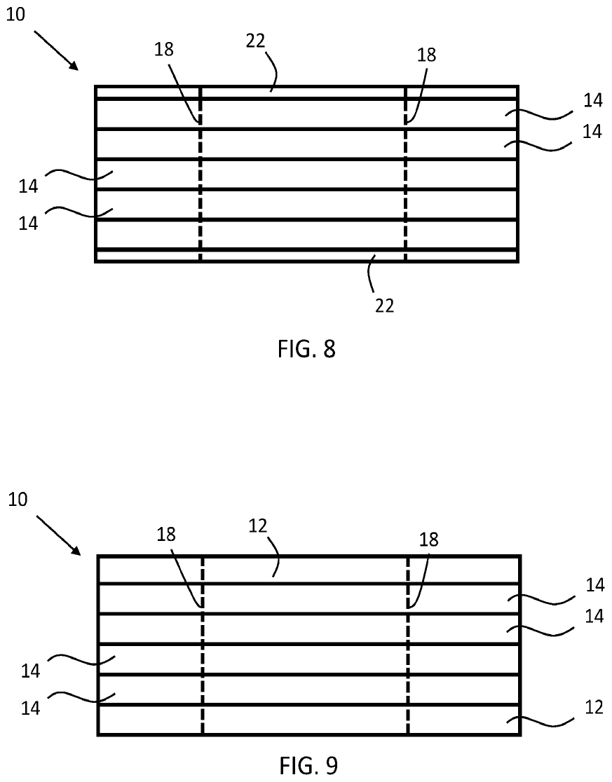

FIG. 8 illustrates another cross-section of an article 10 in accordance with the present teachings. As shown, the article 10 includes a plurality of stacked nonwoven layers 14 sandwiched between opposing metallic layers 22. Thus, the article 10 may beneficially include a metallic layer 22 on opposite sides to protect from an external heat source or opposing external heat sources. The metallic layers 22 and the nonwoven layers 14 may be interconnected via bonding regions 18 joining the layers to form the article 10. The bonding regions 18 may include one or more adhesives between the layers to form the article 10. It should be noted that, unlike the remaining exemplary cross-sections described herein, the article 10 of FIG. 8 is free of a lofted fibrous layer. Thus, one may glean from the present teachings that the article 10 can be even further tuned based on a given application.

Additionally, it is envisioned that the metallic layers 22 may sandwich any number of nonwoven layers 14. For example, a single nonwoven layer 14 may be positioned between opposing metallic layers 22. The metallic layers 22 may be perforated, embossed, or both. Moreover, it should also be noted that while nonwoven layers 14 are shown positioned between metallic layers 22, one or more lofted fibrous layers 12 may be used in lieu of the nonwoven layers 14. For example, the article 10 may be free of any nonwoven layers 14 and may include one or more lofted fibrous layers 12 sandwiched between metallic layers 22.

FIG. 9 illustrates a cross-section of an article 10 in accordance with the present teachings. As illustrated, the article 10 is free of any metallic layers 22. Thus, the article may beneficially provide insulation, baffling, reinforcement, or a combination thereof without the added complexity and/or weight of one or more reflective layers 22. However, it also envisioned, as described herein, that the article 10 of FIG. 9 may also include one or more metallic layers 22 if desired based on an application. The article 10 includes a plurality of nonwoven layers 14 adjacent to each other to form a stack of nonwoven layers 14. The stack of nonwoven layers are sandwiched between opposing lofted fibrous layers 12. The layers of the article 10 may be secured to each other via bonding regions 18 as shown. However, one or more adhesives or additional/alternative connection means may also be utilized to form the article 10.

### ILLUSTRATIVE EXAMPLES

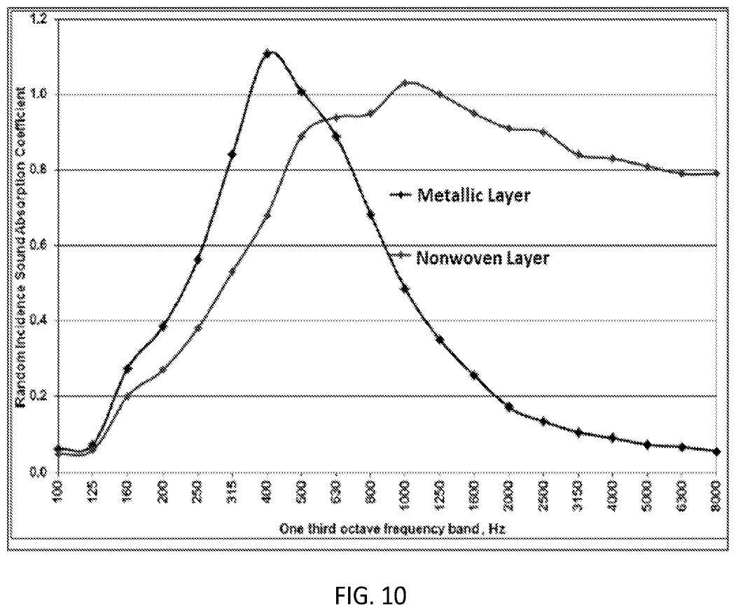

Table 1 illustrates the random incidence sound absorption coefficient of an exemplary article configuration in accordance with the present teaching. The coefficient has been measured for a nonwoven layer located at a side of the article facing the sound source. The coefficient has been measured based on the octave frequency band shown below. Additionally, FIG. 10 illustrates the measurements below based in comparison to a conventional metallic layer, such as an Aluminum foil. As shown, the performance of the nonwoven layer within the article configuration described herein maintains a substantially higher coefficient as the frequency increases.

TABLE 1

| One third octave | Random Incidence Sound |
|---|---|
| frequency band, Hz | Absorption Coefficient |
| 100 | 0.05 |
| 125 | 0.06 |
| 160 | 0.20 |
| 200 | 0.27 |
| 250 | 0.38 |
| 315 | 0.53 |
| 400 | 0.68 |
| 500 | 0.89 |
| 630 | 0.94 |
| 800 | 0.95 |
| 1000 | 1.03 |
| 1250 | 1.00 |
| 1600 | 0.95 |
| 2000 | 0.91 |
| 2500 | 0.90 |
| 3150 | 0.84 |
| 4000 | 0.83 |
| 5000 | 0.81 |
| 6300 | 0.79 |
| 8000 | 0.79 |
| NRC | 0.80 |

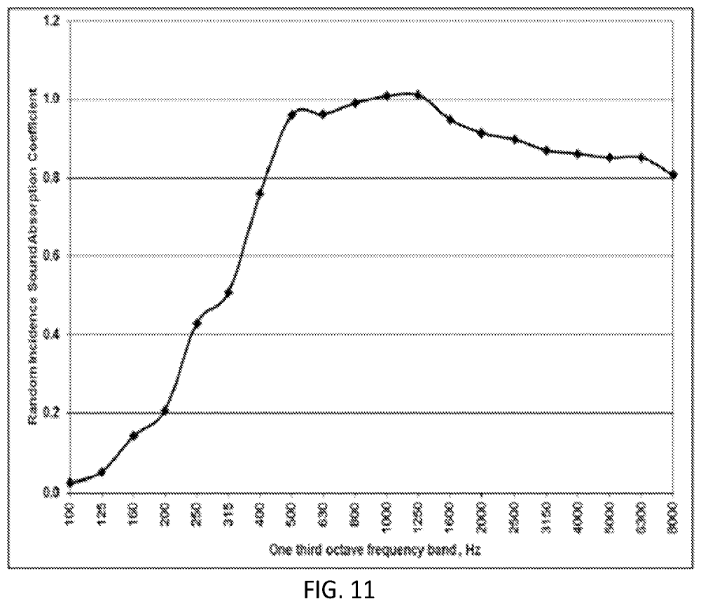

Table 2 illustrates the random incidence sound absorption coefficient of another exemplary article configuration in accordance with the present teaching. The coefficient has been measured for a nonwoven layer located at a side of the article facing the sound source. The coefficient has been measured based on the octave frequency band shown below. Additionally, FIG. 11 illustrates the measurements below. As shown, the performance of the nonwoven layer within the article configuration described herein maintains a substantially high coefficient as the frequency increases.

TABLE 2

| One third octave | Random Incidence Sound |
|---|---|
| frequency band, Hz | Absorption Coefficient |
| 100 | 0.02 |
| 125 | 0.05 |
| 160 | 0.14 |
| 200 | 0.21 |
| 250 | 0.43 |
| 315 | 0.51 |
| 400 | 0.76 |
| 500 | 0.96 |
| 630 | 0.96 |
| 800 | 0.99 |
| 1000 | 1.01 |
| 1250 | 1.01 |
| 1600 | 0.95 |
| 2000 | 0.91 |
| 2500 | 0.90 |
| 3150 | 0.87 |
| 4000 | 0.86 |
| 5000 | 0.85 |
| 6300 | 0.85 |
| 8000 | 0.81 |

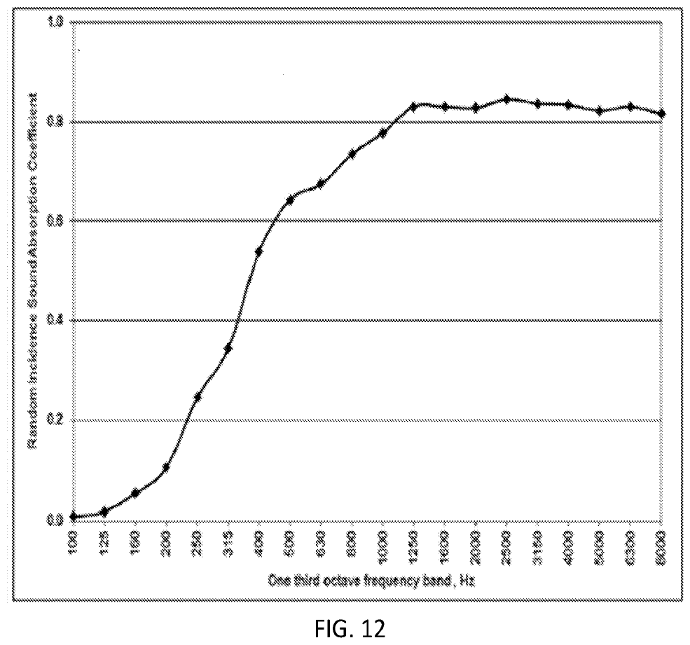

Table 3 illustrates the random incidence sound absorption coefficient of another exemplary article configuration in accordance with the present teaching. The coefficient has been measured for a nonwoven layer located at a side of the article facing the sound source. The coefficient has been measured based on the octave frequency band shown below. Additionally, FIG. 12 illustrates the measurements below. As shown, the performance of the nonwoven layer within the article configuration described herein maintains a substantially high coefficient as the frequency increases.

TABLE 3

| One third octave | Random Incidence Sound |
|---|---|
| frequency band, Hz | Absorption Coefficient |
| 100 | 0.01 |
| 125 | 0.02 |
| 160 | 0.05 |
| 200 | 0.11 |
| 250 | 0.25 |
| 315 | 0.34 |
| 400 | 0.54 |
| 500 | 0.64 |
| 630 | 0.68 |
| 800 | 0.74 |
| 1000 | 0.78 |
| 1250 | 0.83 |
| 1600 | 0.83 |
| 2000 | 0.83 |
| 2500 | 0.85 |
| 3150 | 0.84 |
| 4000 | 0.83 |
| 5000 | 0.82 |
| 6300 | 0.83 |
| 8000 | 0.82 |

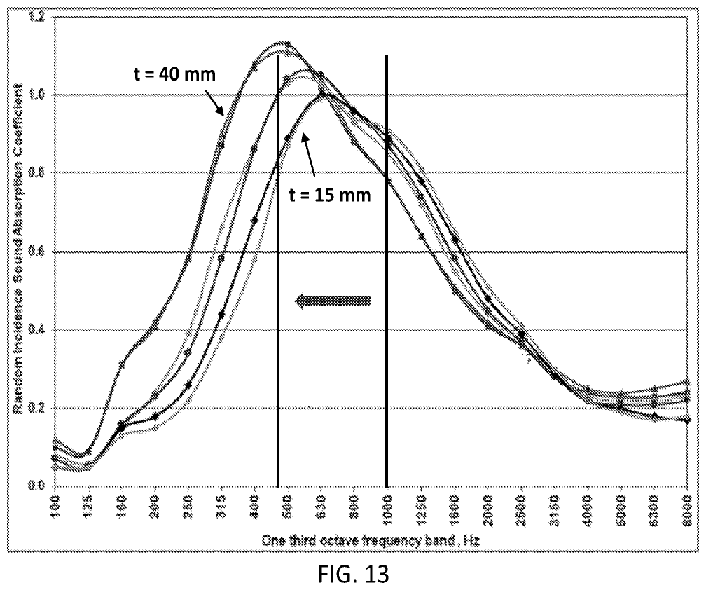

Additionally, FIG. 13 illustrates a comparison of the random incidence sound absorption coefficient of six difference configurations of an insulating article in accordance with our present teachings. Each of the six articles have been tested per ASTM C-423/ISO 354 requirements in a reverberation chamber at one-third octave frequencies. The configurations may vary based upon multiple factors, including layer structures, layer sequencing, thickness of the one or more layers or the overall article, or a combination thereof. For example, as shown in FIG. 13, by adjusting the thickness of the insulating article (e.g., between 40 mm and 15 mm), the insulating article may beneficially adjust the insulation to target lower frequency bands (e.g., target a range of approximately 480 Hertz to about 1,000 Hertz).

Similarly, the configuration of the article may include one or more air-gaps within or adjacent to the article to further optimize and/or modify performance of the article for sound insulation purposes. The air-gap may be configuration for any desired thickness (e.g., distance). For example, the air-gap may be about 5 mm or more, about 15 mm or more, or about 20 mm or more. The air-gap may be about 100 mm or less, about 50 mm or less, or about 25 mm or less.

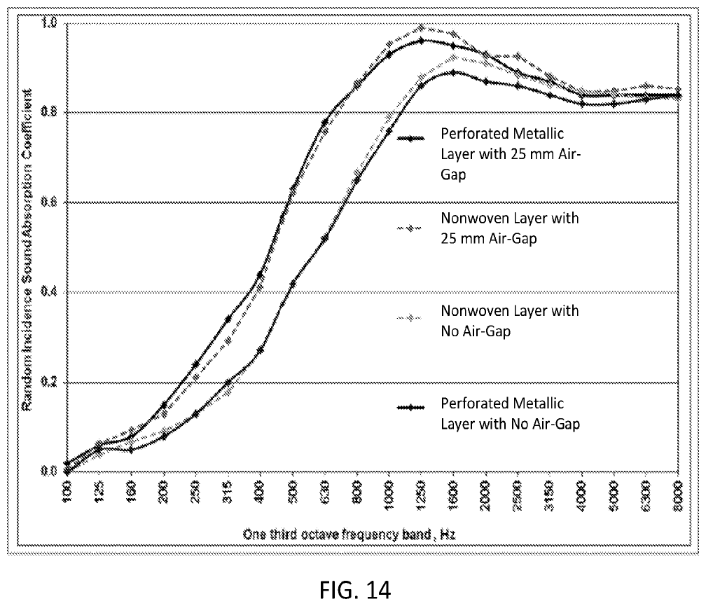

Utilizing an air gap may adjust the random incidence sound absorption coefficient at a desired frequency band. FIG. 14 illustrates the random incidence sound absorption coefficient measured on a one-third octave frequency band for four configurations of the article as described herein: (1) an article having a perforated metallic layer and a 25 mm air-gap; (2) an article having a nonwoven layer free of a perforated metallic layer and a 25 mm air-gap; (3) an article having a nonwoven layer free of a perforated metallic layer with no air-gap; and (4) an article having a perforated metallic layer and no air-gap. As illustrated, the modifications of having a metallic facing layer and/or including an air-gap may beneficially tune the article even further.

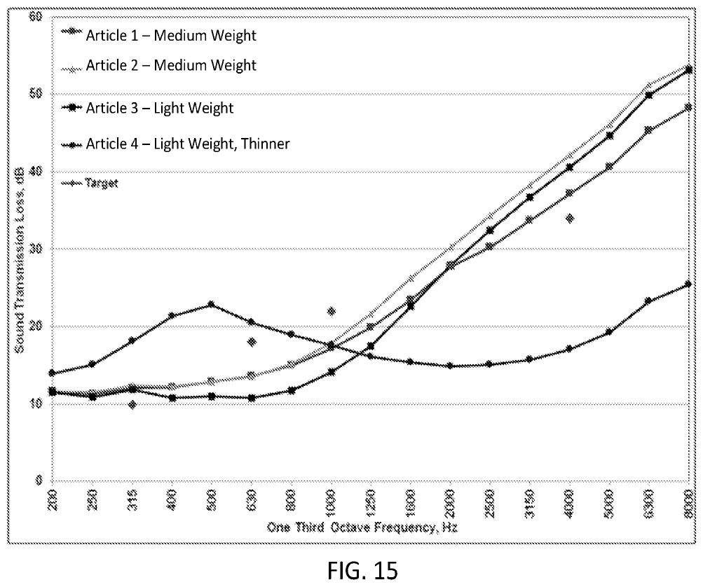

Similarly, FIG. 15 illustrates the sound transmission loss of four article configurations in accordance with the present teachings in comparison to a target loss. The sound transmission loss was tested per ISO 10140-1 at one-third octave frequencies in a reverberation chamber. The articles tested varied in overall weight, and/or thickness to illustrate the performance impacts of such tunability.

Additionally, surface spread of flame testing was conducted on articles in accordance with the present teachings based on testing standards outlined in ISO 5658-2:2006. Beneficially, testing results illustrated that, upon surface spread of the article, the article does not ignite and the critical heat flux is higher than 50 kW/m². Similarly, heat release of fire testing based on testing standards outlined in ISO 5660-1:2015 was conducted on 6 samples-3 samples of the article prior to thermal cycling and 3 samples after thermal cycling. The results of such testing are illustrated in Table 4 below.

TABLE 4

| | | | Test Results | | | |
|---|---|---|---|---|---|---|
| Sr. | | Parameter | Specimen - | Specimen - | Specimen - | |
| No | Test Method reference | unit | 1 | 2 | 3 | Average |
| 1 | Heat Release Rate before | THR- | 1.87 | 1.73 | 1.76 | 1.78 |
| | thermal cycling -ISO 5660-1- | 50 kW/m² | | | | |
| | 50 kW/m2 | | | | | |
| 2 | Heat Release Rate after | THR- | 1.08 | 0.01 | 3.73 | 1.60 |
| | thermal cycling -ISO 5658-1- | 50 kW/m² | | | | |
| | 50 kW/m2 | | | | | |

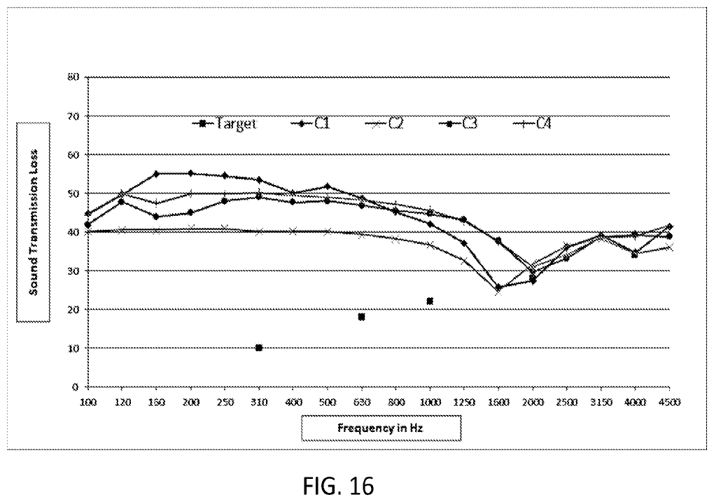

Furthermore, Table 5 below illustrates the sound transmission loss of four article configurations in accordance with the present teachings in comparison to a target loss. The sound transmission loss was tested per ISO 10140-1 at one-third octave frequencies in a reverberation chamber. The articles tested varied in overall weight, thickness, layer configuration, or a combination thereof to illustrate the performance impacts of the beneficial tunability in accordance with the present teachings. Additionally, FIG. 16 illustrates the measurements below. As shown, the performance of the various article configurations met the target loss values, thereby reflecting that, while tunability of the article may alter performance, the articles may still meet sound transmission loss targets.

TABLE 5

| Frequency | Target TL | Specimen | Specimen | Specimen | Specimen |
|---|---|---|---|---|---|
| (Hz) | (dB) | C1 | C2 | C3 | C4 |
| 315 | 10 | 52.50 | 40.08 | 49.06 | 50.18 |
| 600 | 18 | 48.71 | 46.86 | 46.86 | 48.19 |
| 1000 | 22 | 42.07 | 44.71 | 44.71 | 45.60 |
| 2000 | 28 | 27.38 | 29.72 | 29.72 | 30.99 |
| 4000 | 34 | 41.41 | 38.85 | 38.85 | 41.70 |

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference in their entirety for all purposes. Other combinations are also possible as will be gleaned from the following claims, which are also hereby incorporated by reference in their entirety into this written description.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of within a range of 100+/−15.

### ELEMENT LIST

10 Article
12 Lofted Fibrous Layer
14 Nonwoven Layer
16 Pocket
18 Bonding Region
18A Stitching
20 Panel
22 Metallic Layer

1: An article comprising:
(a) lofted fibrous material layer comprising a lofted fibrous material; and
(b) nonwoven layer having a fibrous matrix; and
(c) a metallic layer, wherein the metallic layer is aluminum laminated glass cloth, aluminum foil, stainless steel, or a combination thereof;
wherein the article is configured for thermoacoustic applications to thermally insulate an item or compartment; and
wherein the article absorbs external heat to substantially prevent amplitude of temperature of the item or within the compartment and also substantially prevents noise fluctuation radiated by the item or out of the compartment.

2: The article of claim 1, wherein the metallic layer is disposed on one or more exterior surfaces of the article.

3: (canceled)

4: The article of claim 1, wherein the metallic layer is embossed, micro-perforated, or a combination thereof.

5: The article of claim 1, wherein the item to be insulated is a cabin of a vehicle, an engine bay of the vehicle, or both.

6: (canceled)

7: The article of claim 1, wherein the article is temperature resistant and temperature absorbent at a temperature range of about −30° C. to about 650° C.

8: The article of claim 1, wherein the fibrous matrix includes fibers selected from silica fibers, polyester (PET), polyacrylonitrile (PAN), oxidized polyacrylonitrile (Ox-PAN, OPAN, or PANOX), aramid, olefin, polyamide, imide, polyetherketone (PEK), polyetheretherketone (PEEK), poly(ethylene succinate) (PES), mineral, ceramic, natural, another inorganic fiber, or another polymeric fiber.

9: The article of claim 1, wherein the lofted fibrous material is selected from silica fibers, polyester (PET), polyacrylonitrile (PAN), oxidized polyacrylonitrile (Ox-PAN, OPAN, or PANOX), aramid, olefin, polyamide, imide, polyetherketone (PEK), polyetheretherketone (PEEK), poly(ethylene succinate) (PES), mineral, ceramic, natural, another inorganic fiber, or another polymeric fiber.

10: The article of claim 1, wherein one nonwoven layer and the lofted fibrous materials are thermoformed to form the article.

11: The article of claim 1, wherein one or more air pockets are located between the lofted fibrous material layer and the nonwoven layer.

12: The article of claim 1, wherein the lofted fibrous material layer and the nonwoven layer are secured to one another via stitching, bonding, or both to form the article.

13: The article of claim 1, wherein the article includes one or more localized flexible regions, one or more localized rigid regions, or both.

14: The article of claim 1, wherein the lofted fibrous material, the fiber matrix, or both, includes fibers that are generally vertically, near-vertically, or horizontally oriented.

15: (canceled)

16: (canceled)

17: The article of claim 1, wherein the lofted fibrous material and the fibrous matrix are made from different fibers.

18: The article of claim 1, wherein the nonwoven layer is a fiber cement or rigid layer.

19: The article of claim 1, wherein the article includes at least two abutting nonwoven layers sandwiched between at least two lofted fibrous material layers, and the article is thermoformed or flat-cut.

20: The article of claim 1, wherein the lofted fibrous material layer and the nonwoven layer each have a thickness of no greater than 60 mm.

21: The article of claim 1, wherein the lofted fibrous material has a weight of about 400 to about 2000 GSM.

22: The article of claim 1, wherein the lofted fibrous layer, the nonwoven layer, or both, include a thermoplastic high-temperature binder to promote molding of the article.

23: The article of claim 1, wherein the lofted fibrous layer, the nonwoven layer, or both, include bicomponent fibers, wherein an outer sheath of the bicomponent fibers has a melting temperature greater than 160° C.

24: The article of claim 1, wherein the article has an overall thickness of about 2 mm to about 40 mm.

25: (canceled)
